(19) United States
(12) Patent Application Publication
(10) Pub. No.: US 2009/0000433 A1
(43) Pub. Date: Jan. 1, 2009

(54) SAFETY SPANNER

(76) Inventor: Chih-Ching Hsieh, Taichung City (TW)

Correspondence Address: Chih-Ching Hsieh, Box 8-24, 235 Chung-Ho, Taipei, TW

(21) Appl. No.: 11/770,726

(22) Filed: Jun. 28, 2007

(51) Int. Cl. B25B 23/159

(52) U.S. Cl. 81/477

(57) ABSTRACT

A safety spanner comprises a head for driving an object; a handle connected to the head; the handle including a first body with a length of L1 and second body with a length of L2; the handle further including a first hollow space and a second hollow space; the first hollow space being in the first body and has a length of L and a diameter of φA; the second hollow space being extended from the first body to the second body; a section of the second body near the head being a solid section without any hollow space; the other section of the second body other than the solid section being a non-solid section; the second hollow space having a length of L3 and a diameter of φ B. L1>L and L2>L3, further φ A>φ B.

### FIELD OF THE INVENTION

The present invention relates to spanners, and particularly to a safety spanner, which has a mechanism for bending a neck like section in the handle and the head so as to alert the user that an overlarge force is applied to the driven object. Thus a safety operation is assured.

### BACKGROUND OF THE INVENTION

Generally, a spanner is used to drive an object. The spanner has a head and a handle. The user holds the handle and applies a force to the handle so as to drive the head. If the force driving the object is too great, it is possible that the spanner breaks, especially at a neck portion between the driving head and the portion of the spanner held by the hand of the user, or it is possible that the great force will make the teeth of the spanner wear, or even break, or the object to be driven breaks.

Some prior spanner using strain gauge to provide alarms to the users through a display which may also provide with sound or light alarms. The strain gauge and related display make cost being higher and it is possible that these devices are malfunctioned as no power is supplied or power source has faults.

### SUMMARY OF THE INVENTION

Accordingly, the primary object of the present invention is to provide a safety spanner, which has a mechanism for bending a neck like section in the holding section and the head so as to alert the user that an overlarge force is applied to the driven object. Thus a safety operation is assured.

To achieve above objects, the present invention provides a safety spanner, comprising a head for driving an object; a handle connected to the head; the handle including a first body with a length of L1 and second body with a length of L2; the first body having a larger cross section than that of the second body; the head having a larger cross section than that of the first body; the head further including a first hollow space and a second hollow space; the first hollow space being in the first body and has a length of L and a diameter of φA; the second hollow space being communicated to the first hollow space and being extended from the first body to the second body; a section of the second body near the head being a solid section without any hollow space; the other section of the second body other than the solid section being a non-solid section; the second hollow space having a length of L3 and a diameter of φ B. L1>L2 and L2>L3, further φ A>φ B.

The various objects and advantages of the present invention will be more readily understood from the following detailed description when read in conjunction with the appended drawing.

### BRIEF DESCRIPTION OF THE DRAWINGS

FIG. 1 is a schematic cross sectional view about the structure of the safety spanner of the present invention.

FIG. 2 is a schematic perspective view of the safety spanner of the present invention.

FIG. 3 is a schematic view showing the application of the present invention.

FIG. 4 is a schematic view showing the application of the present invention which shows that the neck section of the safety spanner curves.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

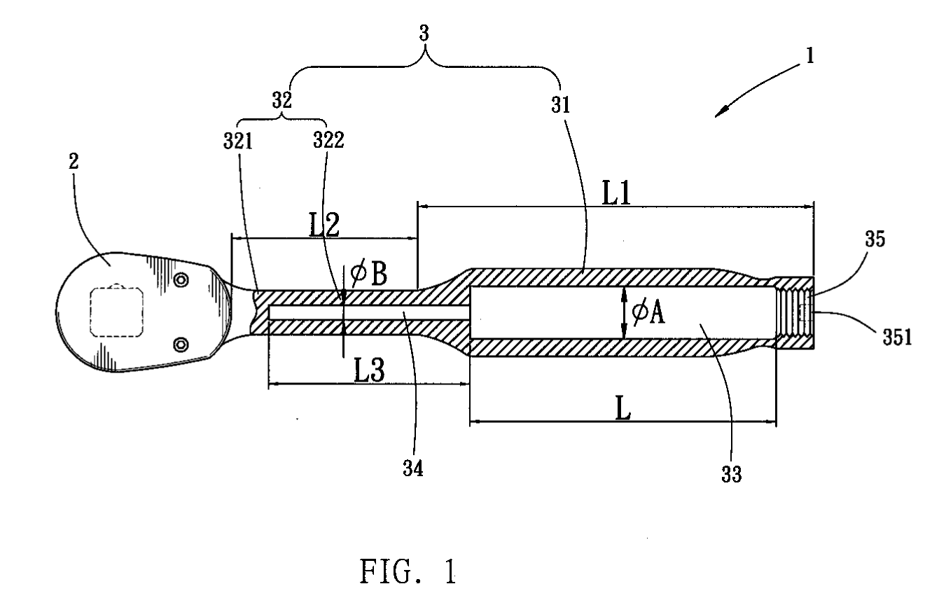

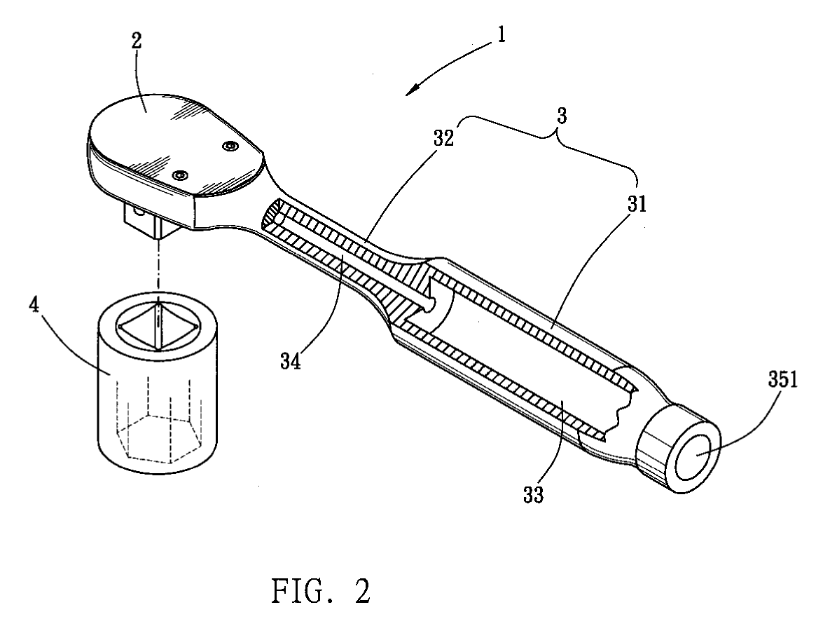

Referring to FIGS. 1 and 2, the safety spanner 1 of the present invention is illustrated. The present invention has the following elements.

A head 2 serves for locking a socket 4.

A handle 3 is connected to the head 2. A force applied to the handle 3 will drive the socket 4 with a fulcrum at the head 2 so that the socket will rotate with a twisting force from the handle 3. At the same moment, the socket 4 will response with a react force which is transferred to the handle 3.

The handle 3 includes a first body 31 with a length of L1 and second body 32 with a length of L2. The first body 31 has a larger cross section than that of the second body 32. The head 2 has a larger cross section than that of the second body 32. The connection of the head 2 and the second body 32 has a tapered section with a larger end at the head 2. The connection of the first body 31 and the second body 32 has a tapered section with a larger end at the first body 31.

The handle 3 further includes a first hollow space 33 and a second hollow space 34. The first hollow space 33 is in the first body 31 and has a length of L and a diameter of φA. The second hollow space 34 is communicated to the first hollow space 33 and is extended from the first body 31 to the second body 32. A section of the second body 32 near the head 2 is a solid section 321 without any hollow space. The other section of the second body 32 other than the solid section 321 is a non-solid section 322. The second hollow space 34 has a length of L3 and a diameter of φ B.

In the present invention, L1>L and L2>L3, further φ A>φ B.

An end of the first body 31 far away from the second body 32 has a threaded hole 35 which is sealed by a seal unit 351 for avoiding undesired objects entering into the first hollow space 33 and second hollow space 34.

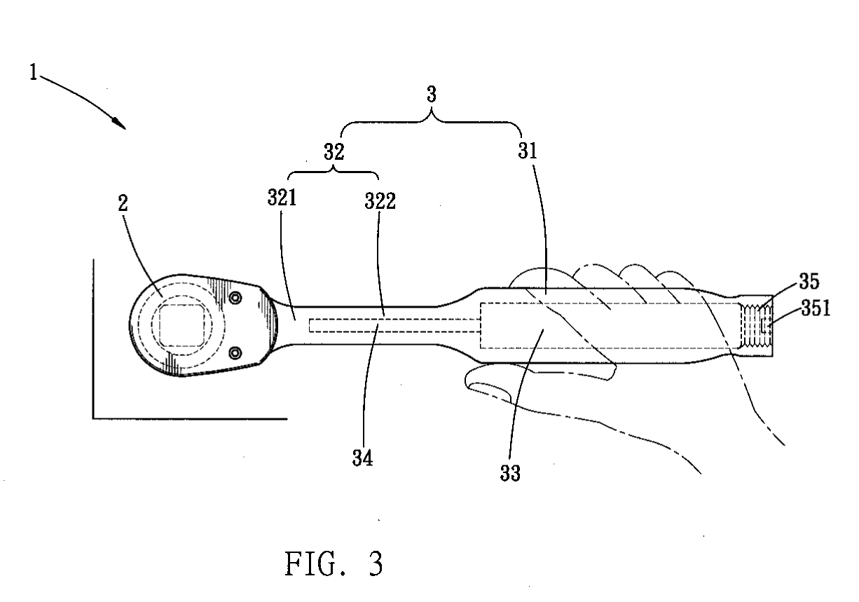

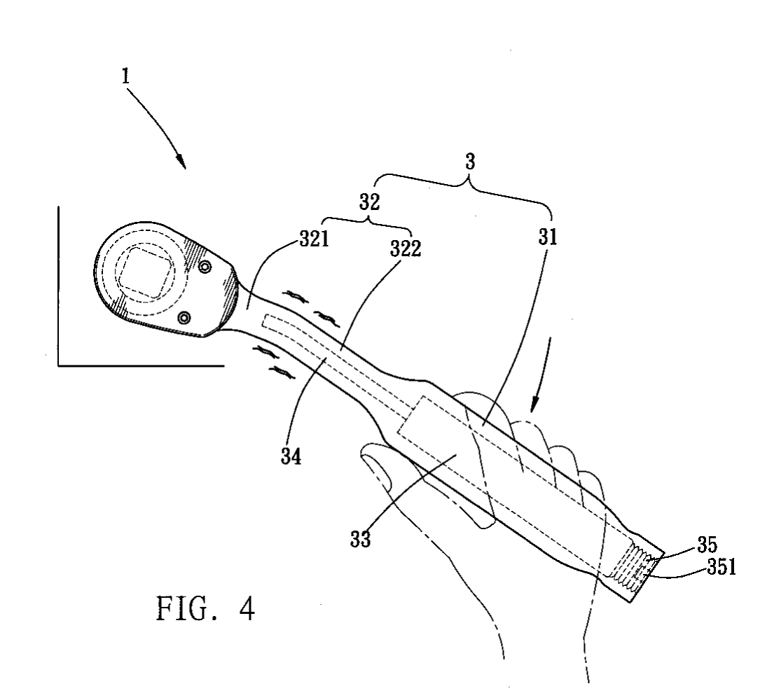

Referring to FIGS. 3 and 4, in operation, the reacted force from the socket has a great stress to the section of the non-solid section 322. In the present invention, because the non-solid section 322 is slender and is hollowed, and thus the second hollow space 34 will bend so as to alert user that the applied force is too great to be tolerant by the head. Thus the user will reduce the force applied to the head 2 of the spanner. However, the solid section 321 has the advantage for avoiding the breaking in the solid section 321 because this point suffers from a great stress from the head 2.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A safety spanner, comprising:
a head (2) for driving an object;
a handle (3) connected to the head (2);
the handle (3) including a first body (31) with a length of L1 and second body (32) with a length of L2; the first body (31) having a larger cross section than that of the second body (32); the head (2) having a larger cross section than that of the second body (32);
the handle (3) further including a first hollow space (33) and a second hollow space (34); the first hollow space (33) being in the first body (31) and has a length of L and a diameter of φA; the second hollow space (34) being communicated to the first hollow space (33) and being extended from the first body (31) to the second body (32); a section of the second body (32) near the head (2) being a solid section without any hollow space; the other section of the second body other than the solid section (321) being a non-solid section; the second hollow space (34) having a length of L3 and a diameter of φB;
wherein the first hollow space (33) has a uniform diameter and the second hollow space has a uniform diameter and the first hollow space 33 is communicated to the second hollow space directly without any tapered section therebetween; and
wherein L1>L and L2>L3, further φA>φB.

2. The safety spanner as claimed in claim 1, wherein a connection of the head (2) and the second body (32) has a tapered section with a larger end at the head.

3. The safety spanner as claimed in claim 1, wherein a connection of the first body (31) and the second body (32) has a tapered section with a larger end at the second body (32).

4. The safety spanner as claimed in claim 1, wherein an end of the first body (31) far away from the second body (32) has a threaded hole (35).

5. The safety spanner as claimed in claim 1, wherein the threaded hole is sealed by a seal unit (351).
